(19) United States
(12) Patent Application Publication
(10) Pub. No.: US 2026/0120111 A1
(43) Pub. Date: Apr. 30, 2026

(54) INTELLIGENT TRANSACTION MANAGEMENT USING A UNIFIED VIEW

(71) Applicant: Oshri Inc., Sherman Oaks, CA (US)

(72) Inventors: Mark Goffman, Sherman Oaks, CA (US); Mark Mucchetti, Sherman Oaks, CA (US); Lindsay Goffman, Sherman Oaks, CA (US)

(21) Appl. No.: 19/371,825

(22) Filed: Oct. 28, 2025

Related U.S. Application Data
(60) Provisional application No. 63/713,471, filed on Oct. 29, 2024.

(51) Int. Cl. G06Q 20/40; G06F 40/205; G06F 40/279; G06F 40/30; G06F 40/40; G06Q 30/0207

(52) U.S. Cl. CPC G06Q 20/407; G06F 40/205; G06F 40/279; G06F 40/30; G06F 40/40; G06Q 30/0215

(57) ABSTRACT

A system for unified transaction management includes an email watcher configured to monitor a user's mailbox, detect new emails satisfying predefined conditions, and trigger a workflow for a new email satisfying the predefined conditions; a Webhook configured to transmit structured or unstructured data from the email watcher to a messaging infrastructure; a pipeline service configured to receive and distribute the structured or unstructured data as a message from the Webhook to downstream processing components; a parser configured to convert unstructured data into structured data representations if data received from the pipeline service includes the unstructured data; a summarizer configured to generate concise summaries of transaction information from the structured data or the structured data representations; and a user application interface configured to present summarized transaction information in a unified, consistent user interface that consolidates transactions from multiple retailers into a single, cohesive dashboard.

### CROSS-REFERENCE TO RELATED APPLICATION

This application claims the benefit of and priority to U.S. Provisional Patent Application No. 63/713,471 filed Oct. 29, 2024, the entire disclosure of which is hereby incorporated by reference in its entirety for all purposes.

### TECHNICAL FIELD

This disclosure relates generally to electronic transaction processing and intelligent event-driven systems, and more particularly to systems and methods for real-time detection and management of refund events and automated offer generation based on transactional data.

### BACKGROUND

Online return and refund systems are widely used in practice because they not only benefit customers in convenience, speed, transparency, and accessibility but also improve businesses' operational efficiency and enhance businesses' brand reputation. Although such online return and refund systems may automate manual processing to a certain extent to reduce time and errors as compared to conventional return and refund mechanisms, these systems face some technical challenges. For example, these systems have difficulty to integrate with multiple inventory systems from multiple sources (e.g., retailer stores, merchants). Either numerous types of products, or inconsistent formats of transaction documents, or different methods for return/refund processing may cause real-time return initiation and processing to be impractical in an integrated system. Even within the context of a single retailer, complicated logistics scenarios may arise such as split shipment, partial return, refund without return, and so on. For example, these systems may not streamline the workflow process to route return requests from different retailers to the appropriate departments for approval or processing. The technical implementation such as label generation, data analysis, and payment processing needed in online return and refund systems may also be restricted due to the multiple sources or complex individual sources. Additionally or alternatively, the existing systems merely send notifications and updates regarding the return/refund status via emails or messages to requesting users, but lack the ability of using the information embedded in the transaction-related emails or messages to handle the return/refund requests and provide the corresponding status.

The foregoing examples of the related art and limitations therewith are intended to be illustrative and not exclusive, and are not admitted to be “prior art.” Other limitations of the related art will become apparent to those of skill in the art upon a reading of the specification and a study of the drawings.

### SUMMARY

The present disclosure addresses the above-mentioned problems and other problems in the existing online return and refund systems by providing systems and methods for real-time detection and management of refund events and automated offer generation based on transactional data.

In one aspect, the disclosure provides a system for unified transaction management, and the system includes an email watcher configured to monitor a user's mailbox, detect new emails satisfying predefined conditions, and trigger a workflow for a new email satisfying the predefined conditions; a Webhook configured to transmit structured or unstructured data from the email watcher to a messaging infrastructure; a pipeline service configured to receive and distribute the structured or unstructured data as a message from the Webhook to downstream processing components; a parser configured to convert unstructured data into structured data representations if data received from the pipeline service includes the unstructured data; a summarizer configured to generate concise summaries of transaction information from the structured data or the structured data representations; and a user application interface configured to present summarized transaction information in a unified, consistent user interface that consolidates transactions from multiple retailers into a single, cohesive dashboard.

In another aspect, the disclosure provides a method for unified management of transaction data, and the method includes monitoring a user's mailbox to detect emails satisfying a specific type of transaction-related criteria; forwarding structured or unstructured data derived from the detected emails via a Webhook to a pipeline service for distributing the structured or unstructured data as a message from the Webhook to downstream processing components; parsing the unstructured data into structured data representations if data received from the pipeline service includes the unstructured data; generating concise summaries of transaction information from the structured data or the structured data representation; and presenting summarized transaction information in a unified, consistent user interface that consolidates transactions from multiple retailers into a single, cohesive dashboard.

The foregoing is a summary and thus contains, by necessity, simplifications, generalizations, and omissions of detail; consequently, the summary is illustrative only and is not limiting in any way. Other aspects, inventive features, and advantages of the systems and/or processes described herein may become apparent in the non-limiting detailed description set forth herein.

### DETAILED DESCRIPTION

The disclosed embodiments have advantages and features that will be more readily apparent from the detailed description, the appended claims, and the accompanying figures (or drawings). A brief introduction of the figures is below.

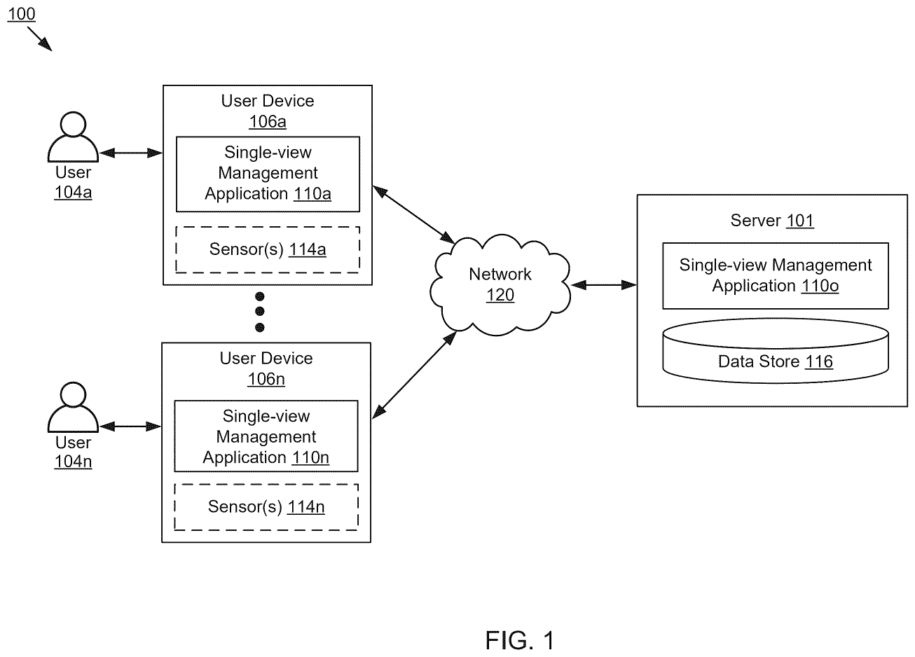

FIG. 1 illustrates an example system for single-view transaction management, according to some embodiments.

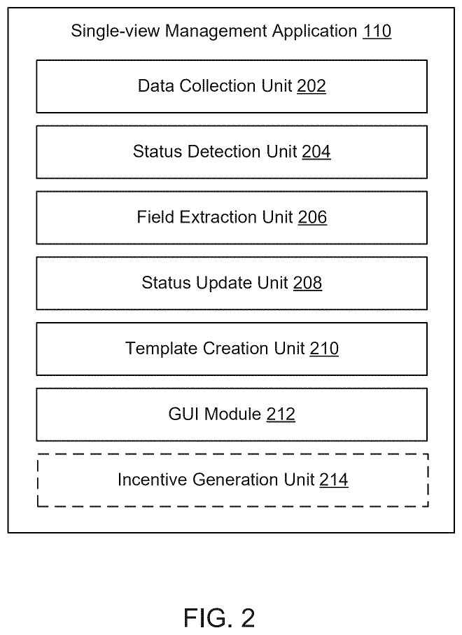

FIG. 2 illustrates example components of a single-view transaction management application, according to some embodiments.

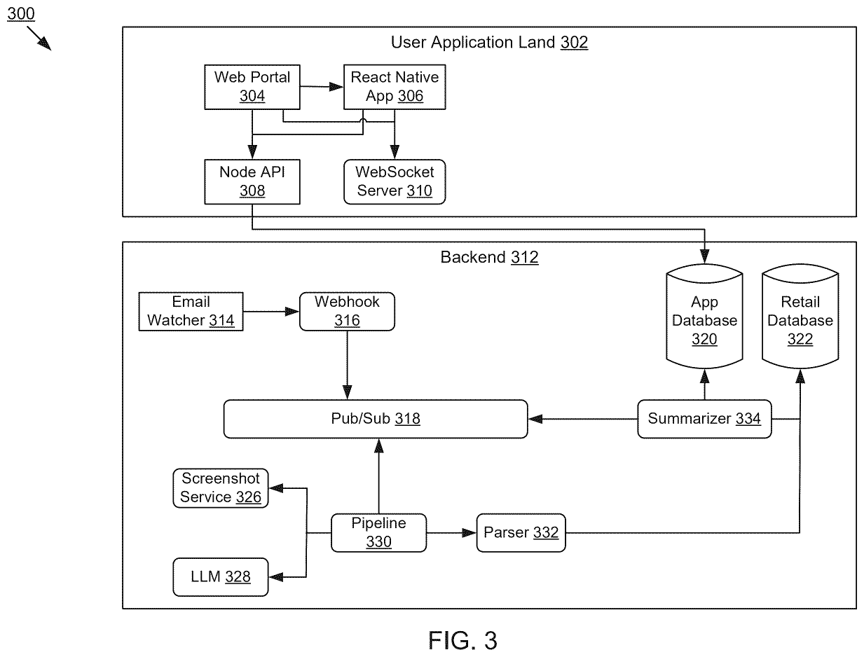

FIG. 3 illustrates an example overall system architecture for single-view transaction management, according to some embodiments.

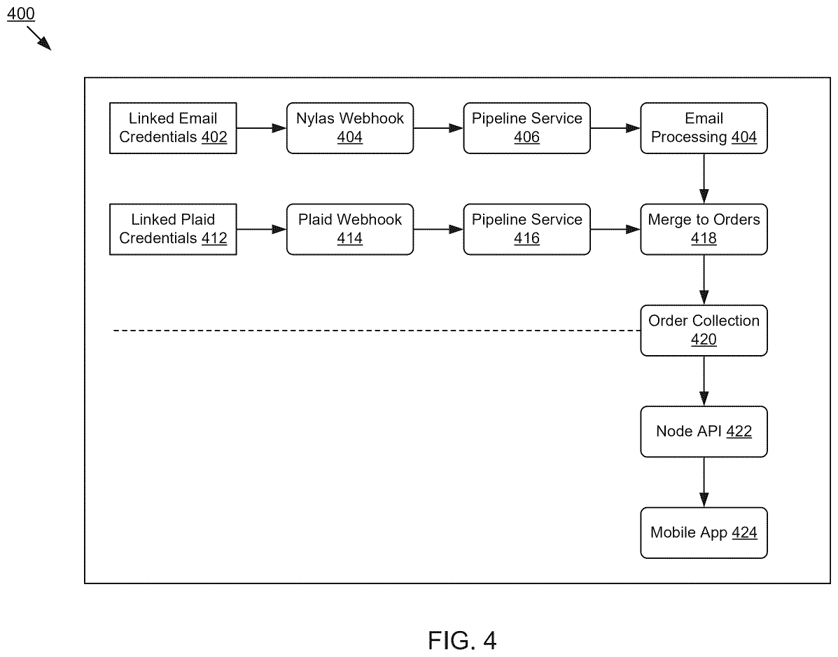

FIG. 4 illustrates an example flow diagram of an order collection process, according to some embodiments.

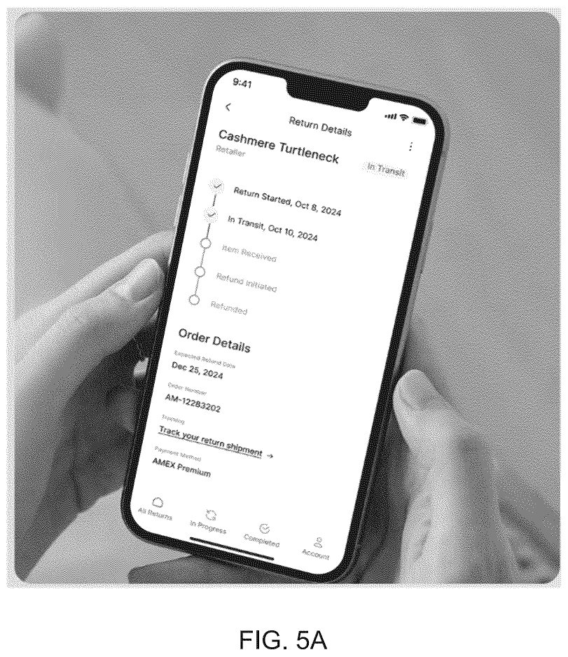

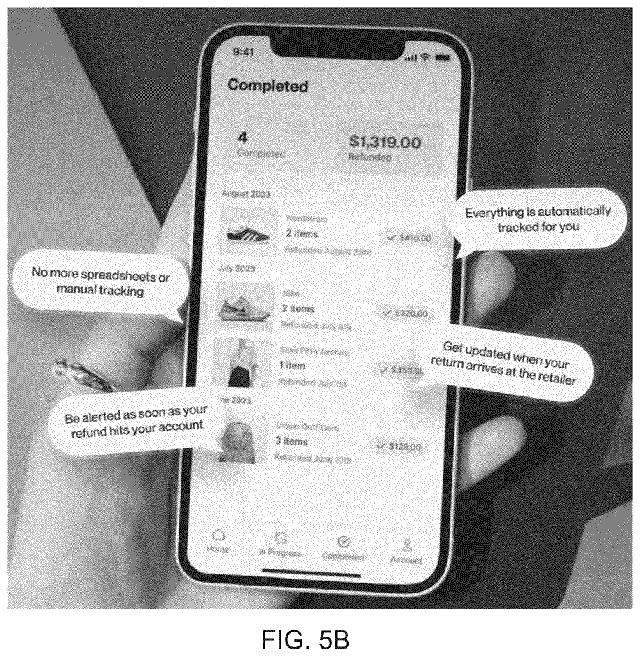

FIG. 5A illustrates a return status tracking interface on a mobile app, according to some embodiments.

FIG. 5B illustrates an interface that consolidates all refund and return activities from multiple retailers into a single, cohesive dashboard, according to some embodiments.

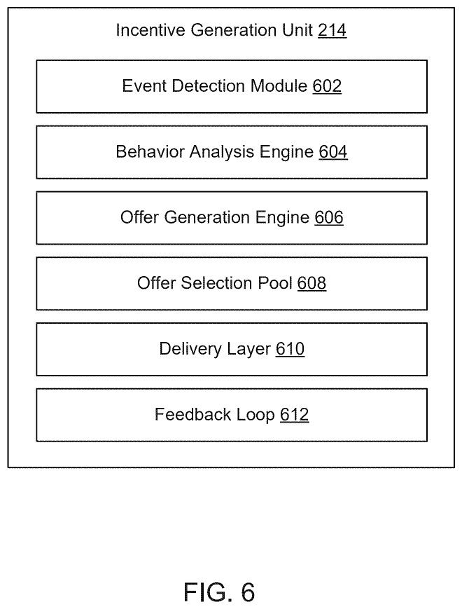

FIG. 6 illustrates an example incentive generation unit for generating and delivering personalized, context-aware incentives, according to some embodiments.

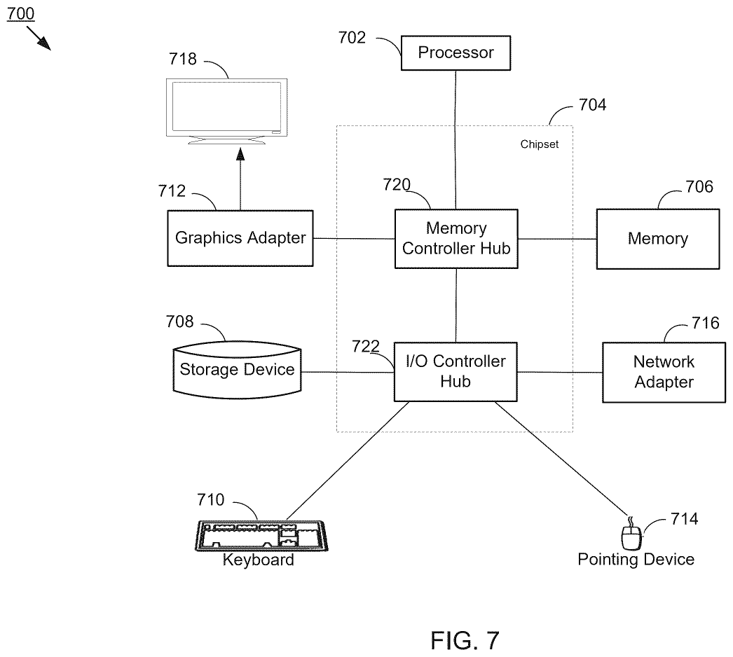

FIG. 7 illustrates an example computing device for implementing the disclosed technology, according to some embodiments.

### DETAILED DESCRIPTION

The Figures (FIGS.) and the following description relate to preferred embodiments by way of illustration only. It should be noted that from the following discussion, alternative embodiments of the structures and methods disclosed herein will be readily recognized as viable alternatives that may be employed without departing from the principles of the present disclosure.

Reference will now be made in detail to several embodiments, examples of which are illustrated in the accompanying figures. It is noted that wherever practicable, similar or like reference numbers may be used in the figures and may indicate similar or like functionality. The figures depict embodiments of the disclosed system (or method) for illustration purposes only. One skilled in the art will readily recognize from the following description that alternative embodiments of the structures and methods illustrated herein may be employed without departing from the principles described herein.

An online transaction system is a digital platform that facilitates the exchange of goods, services, or information over the Internet. For example, an online return or refund transaction system may be used to capture customer requests for returns or refunds (including order details and reasons for return), generate shipping labels and return instructions, send status notifications, and process refunds through secure payment gateways to ensure accurate reimbursements. Such systems can significantly reduce manual operations and errors while improving overall customer experience. However, as discussed above, these online systems often become inefficient when handling multiple return or refund requests originating from various sources or complex individual sources. For instance, it remains challenging to streamline and automate return management for customers who interact with multiple retailers or with retailers managing intricate return workflows.

Managing returns and refunds across multiple sources (e.g., retailers) or complex individual sources is inherently complicated. This process often requires manual handling of return requests, package tracking, and credit card transaction verification, involving different entities at various stages. For instance, retailers primarily focus on shipment and delivery but may lack visibility into the subsequent stages of return processing. Returns are further complicated by the diversity of return types (e.g., partial returns, multiple returns per order) and the variability of return policies, which may differ based on product or service type, merchant or retailer, transaction location, and time of purchase. Currently, customers must spend significant time manually entering return or refund data, often across multiple retailer portals or spreadsheets, or neglect the process entirely, leading to potential losses if issues or required actions are not addressed promptly. Key pain points in existing online transaction systems include parsing emails in varied formats, cross-referencing credit card statements, and ensuring timely refund completion.

Moreover, existing transaction processing systems exhibit additional limitations. Some platforms (e.g., Route®, Rocket Money®) address specific aspects such as order tracking or transaction alerts but fail to provide a unified platform for managing and aggregating returns. For example, Route® lacks integration with financial institutions (e.g., banks), while Rocket Money® functions primarily as a notification service. None of the current systems can synthesize information across multiple retailers or complex individual sources to track each return from initiation through refund completion. Existing online transaction solutions lack a cohesive mechanism to unify and present the entire return process within a single, manageable interface for users. Even those employing pattern matching or artificial intelligence (AI) techniques often require large volumes of training data and still lack the integration and depth necessary for comprehensive return management.

The present disclosure addresses these problems and challenges by introducing a system and method that leverage advanced technologies, such as AI, probabilistic pattern matching, and intelligent email ingestion, to consolidate return-related information into a unified view. This approach enables efficient integration at the source level for initiating and processing customer returns and refund requests. By allowing users to track returns, verify credit card transactions, and manage multiple packages seamlessly, the disclosed system delivers an end-to-end solution. Through the synthesis of diverse data types, including emails, attachments, and metadata, from multiple or complex sources, the system provides a comprehensive and efficient return management experience, addressing the fragmentation and inefficiencies present in existing return and refund processes.

It is to be noted that the benefits and advantages described herein are not all-inclusive, and many additional features and advantages will be further described under the context of specific embodiments. In addition, some additional features and advantages will become apparent to one of ordinary skill in the art in view of the figures and the following descriptions.

### Overall System

FIG. 1 illustrates an example system 100 for single-view transaction management, according to some embodiments of the disclosure. As illustrated, the transaction management system 100 includes one or more user devices 106a, . . . , 106n (together or individually referred to as “user device 106”) coupled to different users 104a, . . . , 104n (together or individually referred to as “user 104”). Also included in the system 100 is a server 101 that communicates with the user device 106 for implementing the functionalities described in the disclosure. In addition, one or more network devices 120 (or simply network 120) may also be included in the system 100 for setting up communications between different components included in the system. For example, a user device 106 may communicate with server 101 through the network 120 during digital verification processes.

In some embodiments, each user device 106 and server 101 may further include an instance of single-view management application 110a/110n/110o (together or individually referred to as “single-view management application 110”), which may implement certain actions necessary for the unified transaction management. For example, a single-view management application 110o on the server 101 may include a status detection unit to identify order information, including a source of the order (e.g., a retailer) and determine an order status for a user 104 (e.g., a customer) based on the information collected for the user 104. In some embodiments, the single-view management application 110o may also include a status update unit for matching the order information with known records to update and present a return status to a requesting user 104. For example, one or more large language models (LLMs) may be employed to detect and update the order status for the user 104. Specifically, the present system 100 allows a user (e.g., a consumer) to write an email requesting a return/refund in his/her usual style, format, or preference following the retailer's return procedure (e.g., filling out a specific return request form from a retailer). In response to receiving the email, the present system can automatically apply the LLMs to classify and analyze the email content, complete the status determination, and update in real time without further user intervention. The present system 100 streamlines this return/refund process even if the user input (e.g., emails) comes from multiple users' free-style input about orders from multiple sources or complex individual sources (e.g., retailers). The specific functions of the single-view management application 110o are described further in detail in FIG. 3.

A user device 106 may also include an instance of a single-view management application 110a/110n, which may be configured to allow the user device 106 to provide the transaction information to the server 101, and to submit other information for return/refund purposes. For example, a single-view management application 110a/110n may control a digital camera/webcam (which is a part of sensor(s) 114a/114n optionally included in the user device 106a/106n) to turn on to take some images of orders, which can be then submitted to the system 100 (e.g., uploaded through the single-view management application 110a/110n, through email, or through other communication channels).

In some embodiments, the disclosed transaction management system 100 may include additional components not described above. For example, one or more data stores (e.g., application database, retailer database) may be included in the disclosed system. These data stores may be included in the user devices 106, server 101 (e.g., a data store 116), or in the cloud (not shown). These data stores may be used to store data collected and generated during the transaction management processes.

### System Implementation

The intelligent transaction management system 100 (e.g., refund or return order system) disclosed herein provides a novel technical framework for automating and integrating the various stages of online transaction processing. In some embodiments, the system is configured to receive and ingest user-submitted data (e.g., emails, messages, or uploaded documents), extract relevant transactional information (e.g., order identifiers, metadata, and refund details), and convert the extracted content into a standardized digital format. For example, the extracted data may be transformed into a hypertext markup language (HTML), extensible markup language (XML), or JavaScript object notation (JSON) format suitable for transmission and interaction across multiple communication channels (e.g., web browsers, mobile applications, or application programming interfaces (APIs)). In some embodiments, the system may employ a cascading intelligence architecture that combines multiple layers of analytical models, including regular expressions, machine learning algorithms, and LLMs, to identify retailers, interpret content, and detect order or refund statuses. This layered approach allows the system to continuously learn from processed data, generate new analytical templates, and improve efficiency and adaptability in subsequent data-processing operations.

FIG. 2 illustrates example components included in a single-view management application 110, according to some embodiments of the disclosure. As illustrated in FIG. 2, the single-view management application 110 may include a data collection unit 202, a status detection unit 204, a field extraction unit 206, a status update unit 208, a template creation unit 210, and a graphical user interface (GUI) module 212. It should be noted that the components of the single-view management application 110 shown in FIG. 2 are provided for exemplary purposes, and not for limitations.

The data collection unit 202 may be configured to receive, aggregate, and process transaction-related data for one or more users (e.g., customers or consumers) through various communication channels. In some embodiments, the data may originate from multiple heterogeneous transaction sources, including but not limited to online retailers, e-commerce marketplaces, payment processors, logistics providers, and financial institutions. The data collection unit 202 may be further configured to capture user-submitted content such as emails, digital forms, text messages, scanned receipts, mobile screenshots, and uploaded documents (e.g., PDF invoices or order confirmations). These diverse input types may be automatically parsed, normalized, and transformed into a unified data representation by the data collection unit 202, to enable downstream processing by the other components of the single-view management application 110.

The transaction data may include a wide range of information, including but not limited to order identifiers, item details, quantities, prices, payment methods, transaction timestamps, fulfillment status, shipping and return addresses, and retailer-specific reference numbers. In some cases, the user may also specify return preferences or refund instructions, such as selecting particular items to be returned, choosing a refund mechanism (e.g., credit card, digital wallet, or direct bank transfer), or entering ancillary information like a preferred contact channel or additional remarks describing the return reason. The data collection unit 202 may interpret this information, extract meaningful fields, and structure it into one or more refund transactions (hereinafter referred to as “orders”), each including at least a refund amount, refund method, and contextual metadata.

To handle data arriving in diverse and inconsistent formats, the data collection unit 202 may include multiple processing layers designed for format detection, decoding, and standardization. In one embodiment, a preprocessing module may first detect the data source and content type (e.g., text, image, structured form, or unstructured email). For instance, when an email message is received, the preprocessing module may isolate its components, such as the sender identity, subject line, message body, and attached files, before transmitting them for semantic analysis. In the case of an image or PDF, an optical character recognition (OCR) engine may be invoked to extract textual content, including line items, SKU numbers, and timestamps, while also capturing metadata such as image resolution, device information, or geolocation tags.

Following extraction, a normalization engine may standardize the data into a consistent internal representation (e.g., JSON, XML, or a proprietary object schema), regardless of its originating source or file format. The normalization may involve tokenization, field mapping, and unit conversions, ensuring that the resulting data adheres to a unified schema. This standardization improves system interoperability and reduces parsing errors when multiple retailers or payment gateways use inconsistent naming conventions or data layouts. The process allows the unified system to ingest information from virtually any digital communication medium without requiring retailer-specific integration, thus reducing maintenance complexity and enabling broad scalability.

In some embodiments, the data collection unit 202 may implement advanced context-awareness through integrated AI components. For example, lightweight natural language processing (NLP) models or LLM-based classifiers may be used to detect key semantic elements, such as intent (“return request,” “refund confirmation,” or “exchange inquiry”), directly from free-form text. The data collection unit 202 may also apply probabilistic pattern recognition or regular-expression libraries to identify recurring structural patterns like order numbers, transaction IDs, or monetary amounts. These models may operate in a cascading or ensemble configuration, where early-stage pattern detection provides coarse classification that is refined by subsequent AI-driven semantic parsing.

The inclusion of such AI-based preprocessing introduces significant technical improvements over conventional systems. Traditional data collection modules rely on static templates, which require manual reconfiguration when retailer communication formats change. In contrast, the disclosed architecture allows the system to dynamically adapt to new data patterns through model retraining and reinforcement. This adaptability minimizes system downtime and enhances data accuracy in environments with frequent layout or terminology changes. Moreover, by performing local preprocessing and compression prior to data transmission, the data collection unit 202 may reduce bandwidth consumption and latency, thereby improving throughput and scalability.

In some embodiments, metadata extracted or generated by the data collection unit 202, such as timestamps, source identifiers, and contextual confidence scores, may be stored in association with the structured order data. This metadata supports traceability, auditing, and confidence-weighted processing in subsequent modules (e.g., the status detection unit 204). Collectively, these technical features allow the data collection unit 202 to provide a robust, adaptive, and format-agnostic ingestion pipeline that forms the foundation for the unified transaction management framework disclosed herein.

Referring now to the status detection unit 204, which is configured to identify the source of a transaction (e.g., a retailer, merchant, or payment processor) and determine a current order (i.e., refund request processing) status based on the processed data received from the data collection unit 202. In some embodiments, the status detection unit 204 may utilize a hybrid intelligence framework that combines deterministic pattern-matching logic with probabilistic and semantic inference techniques. The hybrid architecture enables the system to detect complex variations in transaction data that traditional rule-based systems cannot reliably interpret. For example, the status detection unit 204 may analyze textual, visual, or structured inputs to determine whether an order is “received,” “in process,” “refunded,” or “rejected.”

In one implementation, the status detection unit 204 may first perform low-latency pattern recognition using a regular expression (regex) engine to identify distinctive syntactic elements such as order identifiers, tracking numbers, merchant domains, or standardized phrases (e.g., “refund processed,” “label generated”). These detected entities are then passed to an inference module that applies one or more machine learning (ML) models or LLMs for contextual understanding. The ML or LLM layers may analyze sentence structure, intent, and semantics within the email body or message text to infer the precise transaction stage and associated source entity. This layered inference reduces classification errors caused by ambiguous language or retailer-specific jargon.

In some embodiments, the status detection unit 204 may further incorporate a multi-modal analysis pipeline capable of interpreting heterogeneous data formats. For example, if the received input includes an image attachment such as a shipping label or receipt, a vision-based pattern-recognition component may extract visual identifiers (e.g., retailer logos, barcodes, or QR codes) and feed them into the same classification pipeline used for textual analysis. In some embodiments, the system may apply OCR in combination with a convolutional neural network (CNN) feature extractor to identify retailer branding or document layout structures. The resulting visual tokens may be mapped to a source identifier that aids in accurate retailer recognition and workflow routing.

In some embodiments, to improve precision, the status detection unit 204 may employ a confidence-weighted fusion model that consolidates results from multiple classifiers, such as regex matches, NLP intent scores, and image feature probabilities, into a single composite confidence score. This confidence score determines whether the detected status should be automatically updated, flagged for verification, or routed to the template creation unit 210 for retraining. Such probabilistic fusion provides a quantifiable reliability metric that enhances both interpretability and automation.

The disclosed configuration of the status detection unit 204 achieves several technical advantages over conventional systems. Traditional transaction-status detectors depend on static keyword libraries or manually curated templates that must be reprogrammed when retailer communications change format. By contrast, the present disclosure enables dynamic, self-adapting status classification through the combination of cascading regex logic and adaptive AI models. The system can learn new communication patterns, retrain templates automatically based on real-world data, and propagate updated recognition rules across all active instances without manual intervention. This not only reduces maintenance overhead and error rates but also enables real-time scalability across multiple retailers and communication channels.

Additionally, the hybrid pattern-AI framework minimizes computational latency by allowing deterministic pre-filtering to rapidly eliminate irrelevant content before invoking higher-cost semantic inference. The modular structure further allows distributed deployment, where early-stage regex filtering may occur locally on a user device 106, while deeper LLM-based inference is executed on the server 101. Such a distributed workflow improves response time and reduces bandwidth utilization. Collectively, these design features provide a technically improved method for automatically identifying transaction sources and determining order (i.e., refund request processing) statuses within a unified transaction management system, achieving higher accuracy, adaptability, and efficiency than existing solutions.

Referring now to the field extraction unit 206, which is configured to extract, validate, and normalize structured data fields from the processed information received from the status detection unit 204. In some embodiments, the field extraction unit 206 identifies predefined or dynamically learned fields, such as order numbers, transaction identifiers, item names, purchase dates, refund amounts, retailer identifiers, product categories, or user account information, etc. These fields may occur in varying positions, formats, or syntaxes depending on the retailer or data source. To accommodate this variability, the field extraction unit 206 may employ a hybrid extraction pipeline combining graphical analysis, pattern recognition, and machine learning-based parsing.

The graphical analysis component may detect spatial or layout relationships within structured documents such as receipts, invoices, or return labels. For instance, the system may use document object models (DOMs) or coordinate mapping to determine the relative position of key-value pairs (e.g., “Order ID: 12345” or “Refund Total: $72.00”). This enables the system to infer field associations even when document templates vary significantly. Simultaneously, text-based pattern matching using regular expressions or tokenizer-based algorithms may identify numerical sequences, currency symbols, and keyword patterns indicative of specific data fields.

To further improve extraction accuracy, the field extraction unit 206 may integrate OCR and NLP layers to handle unstructured or semi-structured content. For example, when parsing an image attachment of a paper receipt, OCR may convert visual text into a machine-readable format, while an NLP engine applies contextual classification to label detected entities as “merchant,” “date,” “total,” or “tax.” In some embodiments, an LLM may assist in mapping ambiguous text fragments to known data categories using semantic similarity scoring. The system may also apply adaptive field alignment, where previously extracted field patterns are compared against a continuously updated template database to automatically adjust to new retailer layouts or document variations.

In some embodiments, the field extraction unit 206 may include a data validation submodule that performs consistency checks between extracted field values and reference datasets, such as retailer databases or previous transactions stored in the application database 320. This validation process may use cross-referencing, fuzzy matching, and checksum verification to identify data anomalies (e.g., missing digits, incorrect currency, or mismatched dates). In response to detected inconsistencies, the system may trigger automated correction routines or flag the record for review by the template creation unit 210, allowing continuous refinement of field recognition accuracy over time.

The described field extraction unit 206 provides several technical improvements over conventional data parsing methods. Traditional systems rely on static form templates that fail when encountering unseen document layouts or non-standardized retailer formats. In contrast, the disclosed multi-layer extraction pipeline combines deterministic pattern matching with adaptive AI-driven learning, enabling the system to self-correct and generalize across previously unseen input types. This adaptability eliminates the need for frequent manual reprogramming and allows near real-time integration of new retailer sources.

Moreover, by separating field extraction into concurrent visual, textual, and semantic analysis threads, the disclosed field extraction unit 206 achieves significant gains in both processing throughput and fault tolerance. The architecture supports asynchronous extraction tasks, enabling scalable deployment in distributed computing environments where individual microservices handle specific data types (e.g., image receipts vs. email confirmations). These features collectively provide a robust, extensible mechanism for transforming diverse, unstructured transaction information into standardized, validated data suitable for unified management. As such, the field extraction unit 206 represents a noteworthy technical enhancement in the disclosed intelligent transaction system, improving data accuracy, system adaptability, and overall processing efficiency.

Referring now to the status update unit 208, which is configured to merge, reconcile, and update transaction records using the structured data received from the field extraction unit 206. In some embodiments, the status update unit 208 maintains active synchronization between user-level orders, retailer-level data, and application-level records stored in the databases 320 and 322 (described later). The system may use a record-linking process that compares extracted fields (e.g., order numbers, transaction dates, retailer identifiers, or item descriptions) against known reference data to determine whether a corresponding order related to a refund request already exists. When a match is found, the status update unit 208 updates the relevant order or refund status; if no match exists, the unit may create a new transaction entry.

To accommodate inconsistencies in data originating from heterogeneous sources, the status update unit 208 may employ fuzzy-matching algorithms and probabilistic data association techniques. These algorithms compare partially similar data strings or values by computing edit distances, phonetic equivalence, or token overlap scores to identify near-matches that would otherwise be missed by strict equality comparison. For example, if a user email contains an order ID “123-45-A,” while the retailer database records “12345A,” the fuzzy-matching logic recognizes both as referring to the same transaction. The status update unit 208 may assign a confidence score to each potential match and use threshold-based logic to decide whether to update, merge, or flag a record for manual or automated review.

In some embodiments, the status update unit 208 may operate as a transaction reconciliation engine that maintains version control and temporal consistency of refund information. Each update operation may be timestamped and associated with a processing context (e.g., source type, communication channel, or processing node). When multiple data inputs refer to the same transaction, the system may apply conflict-resolution policies such as “latest-timestamp wins,” “highest-confidence value,” or “verified-source priority.” These policies ensure that refund status information remains accurate and consistent across all connected systems. The reconciliation engine may also record provenance metadata for auditability, enabling trace-back of each update to its originating source and processing method.

To facilitate real-time responsiveness, the status update unit 208 may integrate an event-driven pipeline with message-queueing mechanisms (e.g., Pub/Sub architecture) to propagate updates to other system components and user interfaces as soon as changes occur. For example, when the system detects that a retailer has approved a refund, the update event may be broadcast instantly to the GUI module 212, which may notify the user 104 of the status change. This real-time synchronization improves transparency and reduces latency between transaction events and user feedback.

The status update unit 208 provides multiple technical improvements over conventional order-tracking and refund-management systems. Traditional approaches rely on static relational updates that cannot tolerate inconsistent data or asynchronous event timing, often resulting in duplicate or missing records. The disclosed system introduces a self-adaptive reconciliation framework that combines deterministic matching, probabilistic inference, and continuous synchronization to maintain data integrity in dynamic, multi-source environments. By automating the identification and correction of discrepancies in order data, the status update unit 208 eliminates substantial manual processing overhead and reduces human error.

Additionally, because the architecture supports distributed execution, different nodes of the unified transaction management system may perform localized updates while maintaining eventual global consistency through consensus mechanisms or timestamp-based reconciliation. This distributed capability enables horizontal scalability and fault tolerance across large transaction volumes. The technical effect of these improvements is a more accurate, resilient, and efficient order-status updating process that supports real-time integration between users, retailers, and financial institutions within a single, unified view.

FIG. 5A shows a return status tracking interface on a mobile app. From a status update perspective, it illustrates a real-time, step-by-step progression of a product return, beginning with Return Started and In Transit, followed by upcoming stages such as Item Received, Refund Initiated, and Refunded. Each stage is timestamped, visually marked with check indicators for completed steps, and clearly communicates the current phase (“In Transit”). Below the timeline, the app provides order details (order number, transaction ID, expected refund date, payment method) and a link to track shipment, allowing users to monitor the return process transparently from initiation through refund completion.

Referring now to the template creation unit 210, which is configured to automatically generate, adapt, and optimize templates used by the system for data extraction, pattern recognition, and classification. In traditional transaction-management systems, templates must be manually created and updated whenever retailer formats or communication styles change. Such manual intervention is time-consuming and prone to errors, making large-scale integration impractical. The present disclosure introduces a cascading intelligence framework that enables automated, data-driven template creation and refinement using AI and ML techniques.

In some embodiments, the template creation unit 210 may receive feedback data from the status detection unit 204, the field extraction unit 206, and the status update unit 208. When the system encounters data that cannot be accurately processed or classified, such as an unknown retailer format or new communication layout, the template creation unit 210 initiates a self-learning process. This process employs one or more AI models, including LLMs, to analyze misclassified or unrecognized data patterns, identify recurring features, and generate new template structures or field mappings that improve future recognition. Once validated, the generated templates are stored in a central template repository accessible by other system modules.

In some embodiments, the template creation unit 210 may utilize a multi-layered AI architecture that operates in a cascading manner. A first layer of pattern-recognition models may identify basic syntactic structures (e.g., header fields, line item delimiters, or metadata markers). A second layer comprising statistical or ML-based models may cluster similar document types by layout, language, or content density. A third layer, implemented through one or more LLMs, may perform semantic interpretation and field association, mapping detected textual entities to conceptual categories such as “refund confirmation,” “order number,” or “shipping update.” The combination of these layers allows the system to autonomously construct generalized templates that remain robust even as retailer formats evolve.

In some embodiments, to ensure reliability, each newly generated template may undergo a validation and versioning process. Specifically, the template creation unit 210 may apply synthetic test data or known sample inputs to evaluate the accuracy, coverage, and confidence level of the new template. Versioning metadata (e.g., creation timestamp, training dataset identifier, model version) may be stored alongside the template, enabling reproducibility and traceability. This automated validation pipeline minimizes human review requirements and allows templates to be safely deployed to production in real time.

The technical advantages provided by the template creation unit 210 are significant. By automating the generation and maintenance of templates, the system eliminates the need for continuous manual updates when retailer formats or transaction workflows change. This automation reduces downtime, increases operational scalability, and allows for rapid adaptation to new data sources without code modification. Furthermore, the cascading AI-based design enables continuous self-improvement: the system learns from historical processing errors and user feedback, progressively enhancing the precision and recall of field extraction and classification over time.

The template creation unit 210 also supports a distributed template deployment model, where validated templates are propagated to edge nodes or user devices 106 for localized inference, reducing network latency and improving system responsiveness. In addition, templates may be dynamically weighted based on usage frequency or accuracy, allowing the system to prioritize high-performing templates during real-time processing. Collectively, these features provide a self-evolving data-processing infrastructure that not only improves efficiency and accuracy but also introduces a fundamental architectural advancement in automated transaction management technology.

Referring now to the GUI module 212, which is configured to facilitate interactive communication between users (e.g., customers, administrators, or retailers) and the intelligent transaction management system 100. In some embodiments, the GUI module 212 serves as the centralized visualization and control layer of the single-view management application 110, enabling real-time presentation of transaction data, refund status, and system notifications through a unified interface. In some embodiments, the GUI module 212 may communicate bidirectionally with backend components, including the status detection unit 204, the field extraction unit 206, the status update unit 208, and the template creation unit 210, via APIs and event-driven message queues.

The GUI module 212 may be implemented using web-based frameworks such as React® or Angular®, or as a cross-platform mobile application developed using React Native® or equivalent technologies. These frameworks enable the GUI to render adaptive layouts optimized for different devices (e.g., smartphones, tablets, and desktop computers). In some embodiments, the GUI module 212 may include a real-time rendering engine that dynamically updates the display based on asynchronous events received from backend services, such as refund approvals, shipping label confirmations, or transaction verifications. This ensures that the information presented to the user reflects the most recent transaction state without requiring manual refresh operations.

In one embodiment, the GUI module 212 may include a contextual data visualization subsystem that aggregates multi-source transaction data into an interactive dashboard. This subsystem may use data normalization results from the data collection unit 202 and extraction fields from the field extraction unit 206 to present a consolidated transaction timeline, highlighting each stage of a return or refund process (e.g., initiation, approval, shipment, refund credit). The interface may further include progress indicators, confidence meters (based on the status detection unit 204's scoring outputs), and graphical representations of refund flow paths. Such visualization enables both users and administrators to monitor refund events and identify bottlenecks in real time.

In some embodiments, to improve user experience and data security, the GUI module 212 may support authentication protocols and secure communication layers such as OAuth® 2.0 and transport layer security (TLS). In some embodiments, the GUI module 212 may also integrate role-based access control (RBAC) to restrict access to sensitive financial or personal information. For example, a consumer-facing interface may display refund summaries, while an administrative interface may expose deeper analytics, fraud detection alerts, or template performance metrics.

The GUI module 212 introduces several technical benefits that extend beyond conventional interface implementations. Unlike static web dashboards that rely on batch updates, the disclosed GUI operates as an event-synchronized, data-reactive interface, automatically rendering real-time changes originating from multiple data sources and backend services. This architecture reduces latency, eliminates redundant polling, and enhances system efficiency by transmitting updates only when relevant events occur. Additionally, the unified design of the GUI provides users with a single consolidated view of their transaction and refund activities across multiple retailers, communication channels, and payment sources, thereby solving the fragmentation problem inherent in existing systems.

FIG. 5B illustrates an interface that consolidates all refund and return activities from multiple retailers into a single, cohesive dashboard (which is an example implementation of a single-view or unified view). It presents a summarized view of completed returns, grouped by date and retailer, alongside corresponding refund amounts, providing users with an at-a-glance understanding of total refunded value, thereby allowing users to track everything in one place. Each entry (e.g., Nordstrom®, Nike®, Saks Fifth Avenue®) displays the number of items returned, the refund amount, and the refund completion date.

From a design standpoint, this single consolidated view eliminates the need for users to manage separate spreadsheets, track multiple retailer portals, or manually reconcile refunds. Instead, the GUI harmonizes heterogeneous data sources into a consistent visual framework, enabling automatic updates, refund alerts, and tracking across all merchants. This unified design enhances transparency, reduces user effort, and supports efficient monitoring of refund and return progress from one centralized application.

From a technical perspective, the GUI module 212 improves both scalability and maintainability. Its modular component architecture allows independent updates to visualization logic, interaction handlers, and data-binding layers without interrupting backend processes. Furthermore, the GUI's integration with AI-generated templates enables adaptive rendering, for instance, dynamically reformatting visual elements or prompts based on the detected retailer, transaction type, or language pattern. These improvements collectively provide a more intelligent, responsive, and user-centric transaction interface, transforming the traditional return/refund experience into an integrated, real-time, and adaptive digital workflow.

Referring back to FIG. 2, in some embodiments, one or more other components may be included in the single-view management application 110 to perform other functionalities not described above. In one embodiment, the single-view management application 110 may be configured to perform order and delivery tracking. For example, a tracking module (not shown) may be configured to track orders and deliveries. This tracking module may also be adapted to target any combination of email, package, and/or credit synthesis. In some embodiments, the single-view management application 110 may be extended to support functionalities such as fraud detection, customer support automation, or other applications that utilize integrated email, package, and credit data synthesis. Furthermore, the single-view management application 110 may be implemented as a web extension, integrated into business-to-business (B2B) logistics platforms, or expanded to provide data feeds for other data intelligence systems or analytical products. In some embodiments, the single-view management application 110 may optionally include an incentive generation unit 214, as shown in FIG. 2, which is configured to intercept refund or return events within an e-commerce environment and dynamically generate time-sensitive, personalized incentive offers (or simply incentives) to increase post-purchase engagement and customer retention, as further described in detail later in FIG. 5.

FIG. 3 illustrates an example overall system architecture 300 for providing an environment for single-view transaction management, according to some embodiments. As illustrated, the disclosed system 100 may include a user application land 302 on the user end (e.g., user device 106) that receives user requests and provides output to a user (e.g., via a unified GUI), and a backend 312 on the server side (e.g., server 101) that handles the user request processing and generates the output.

As illustrated in FIG. 3, the user application land 302 may include a web portal 304, a React Native® app 306, a node API 308, and a WebSocket® server 310.

The web portal 304 may be a specially designed, browser-accessible interface that aggregates and presents information from multiple heterogeneous data sources, such as emails, online retailer databases, shipping services, and financial institutions, in a unified and consistent format. Each data source may be represented through an independent content area (or portlet) on the portal interface. These portlets may dynamically render data retrieved via standardized APIs, secure email ingestion pipelines, or structured web crawlers. In some embodiments, the web portal 304 may employ a modular, component-based architecture using a modern front-end framework such as React.js®, Angular®, or Vue.js®, enabling efficient rendering, state management, and component reuse across different sections of the interface.

In some embodiments, a user may configure the web portal 304 to selectively display or hide specific information, reorder dashboard elements, or apply filters and sorting criteria to tailor the display to individual preferences or workflow requirements. The presentation layer may support asynchronous data fetching using asynchronous JavaScript and XML (AJAX) or WebSocket® protocols to ensure real-time updates without full-page reloads, providing a seamless and interactive user experience.

In some embodiments, variants of the web portal 304 may include mashups and intranet dashboards customized for enterprise users, such as logistics coordinators or customer support managers, allowing them to monitor return and refund activity across multiple retailers or departments. The degree of uniformity in data presentation may depend on user roles, the diversity of the underlying content, and the specific operational context. Accordingly, the disclosed web portal 304 provides a scalable, secure, and configurable front-end interface that delivers a unified visualization of multi-source transaction data for both consumers and enterprise users.

React Native® app 306 (also known as RN) is a popular JavaScript-based mobile app framework that allows one to build natively-rendered mobile apps for iOS® and Android®. The framework lets one create an application for various platforms by using the same codebase. React® components, central to React Native®, enable developers to interact seamlessly with existing native code, enhancing the framework's ability to integrate with native APIs and allowing existing native teams to work much faster. This interaction between React® components and existing native code expands the capabilities of native app development to new teams of developers, making it a highly efficient and versatile solution for mobile app development. In the disclosed system, by including a React Native® app 306, it may facilitate the development and implementation of the disclosed single-view management application for different developers. However, it should be noted that other apps that achieve similar functions can also be used in the present disclosure, and thus the React Native® app 306 is provided in the disclosure for illustrative purposes but not for limitations.

Node.js® is a cross-platform, open-source JavaScript® runtime environment that can run on Windows®, Linux®, Unix®, macOS®, and more. Node.js® runs on the V8 JavaScript® engine, and executes JavaScript code outside a web browser. Node.js® lets developers use JavaScript® to write command-line tools and for server-side scripting. The ability to run JavaScript code on the server is often used to generate dynamic web page content before the page is sent to the user's web browser. Consequently, Node.js® represents a “JavaScript everywhere” paradigm, unifying web-application development around a single programming language, as opposed to using different languages for the server-versus client-side programming. Node.js® has an event-driven architecture capable of asynchronous I/O. These design choices aim to optimize throughput and scalability in web applications with many input/output operations, as well as for real-time Web applications (e.g., real-time communication programs and browser games).

WebSockets® are used for real-time, event-driven communication between clients and servers. They are essential for applications needing instant updates, such as real-time chat, messaging, and multiplayer games. In traditional HTTP, clients continuously poll the server, causing increased latency and inefficiency. In the disclosed system, by including a WebSocket server 310, it may facilitate real-time, event-driven communications between client devices and server, so that any event related to the unified transaction management can be timely communicated to a target entity in the system for instant processing.

It should be noted that the components included in the user application land 302 are merely for illustrative purposes, but not for limitations. In some embodiments, fewer or more components may be included in a user application land 302. For example, in some embodiments, the user application land 302 may include one or more components for data processing or parsing, which may include use of Python® or another different programming language for such purposes.

In the following, one example implementation related to the unified transaction management within the user application land 302 is further described. Briefly, through the web portal 304 or the React Native® app 306, a user may submit one or more return or refund requests by uploading or forwarding related data, such as emails, messages, images, or order confirmations. The web portal 304 and React Native® app 306 may each serve as user-facing interfaces of the single-view management system, providing access to a variety of services, resources, and information through a unified digital experience. For instance, the React Native® app 306 may function as a cross-platform mobile client installed on the user device 106 of the user 104, enabling secure authentication, push notifications, and real-time synchronization with the web portal 304 via shared APIs and WebSocket® connections.

Upon user submission, the data (e.g., an email containing return order information or refund details) may be transmitted securely to the backend 312 on the server 101 through the Node.js-based API 308. The API 308 may perform functions such as input validation, session management, and metadata tagging before storing the structured and unstructured data in the application database 320. The WebSocket® server 310 may maintain persistent bidirectional communication channels between the user application land 302 and the backend 312, allowing for real-time status updates, transaction event notifications, and asynchronous processing feedback. For example, once a return request is processed by the backend 312, the WebSocket® server 310 may push live updates to both the web portal 304 and the React Native® app 306, instantly reflecting status changes such as “label generated,” “package received,” or “refund approved.”

Accordingly, the coordinated interaction among the web portal 304, the React Native® app 306, the node API 308, and the WebSocket® server 310 enables a seamless, real-time user experience across devices and platforms. This architecture allows users to initiate, monitor, and manage return and refund requests efficiently, while ensuring that updates and notifications remain synchronized between the mobile and web interfaces under the unified transaction management framework.

Referring now to the backend 312 server, it may include an email watcher 314, a webhook 316, a publish-subscribe (Pub/Sub) 318 service, an application database (DB) 320, a retailer database 322, a summarizer 334, a screenshot service 326, an LLM model 328, a pipeline 330, and a parser 332.

The email watcher 314 may be configured to continuously monitor one or more designated mailboxes for incoming messages that meet predefined conditions or filter rules. For instance, the email watcher 314 may use the Internet message access protocol (IMAP) or simple mail transfer protocol (SMTP) interfaces to access user mailboxes and detect new messages at configurable time intervals, which may be set via a timer or event-driven trigger. When a new email is detected that satisfies the applicable condition (e.g., containing order confirmations, refund notifications, or shipping updates), a corresponding workflow is automatically initiated. This workflow may include parsing the email headers, body content, and attachments; identifying structured and unstructured data; and extracting relevant information such as merchant name, order number, item details, timestamps, and refund status.

The webhook 316 may serve as a lightweight, event-driven communication mechanism for transmitting the captured email data to other components of the system. Implemented over HTTP, the webhook 316 may automatically post structured JSON payloads to predefined endpoints whenever a new qualifying email event occurs. In one exemplary implementation, the webhook 316 may be configured to forward email data received from the email watcher 314 to the Pub/Sub 318 service for downstream processing.

The Pub/Sub 318 service may function as a fully managed, distributed messaging middleware that supports asynchronous communication between the front-end email ingestion layer and various backend microservices. The Pub/Sub 318 service may decouple message producers (e.g., the webhook 316) from message consumers (e.g., email summarization modules, data enrichment pipelines, or database writers), thereby enabling scalable and fault-tolerant event handling. For example, each incoming email event may be published to a specific topic within Pub/Sub, and multiple subscriber components may concurrently consume the message for specialized processing tasks, such as natural language summarization, sentiment analysis, metadata tagging, and classification of return/refund intent. The processed or summarized results may subsequently be stored in the application DB 320 and/or the retailer DB 324 for further retrieval, analytics, and unified display through the user interfaces.

In some embodiments, the system may also employ message acknowledgment, retry, and dead-letter queue mechanisms provided by the Pub/Sub 318 to ensure reliable and lossless message delivery even in the presence of transient network or service failures. This modular and event-driven architecture allows for efficient, scalable, and resilient processing of large volumes of transaction-related email data across multiple users and retailers.

The screenshot service 326 may be a dedicated microservice configured to capture, render, and store visual representations of webpages or online portals associated with return and refund transactions. In some embodiments, the screenshot service 326 may utilize a headless browser framework (e.g., Puppeteer®, Selenium®, or Playwright®) to programmatically access merchant or logistics websites (authenticate as needed) and generate screenshots of relevant pages, such as return confirmation screens, refund status dashboards, or shipping label generation pages. The captured screenshots may be processed to remove unnecessary content (e.g., advertisements or non-transactional elements) and converted into standardized image formats (e.g., PNG or JPEG) for efficient storage and retrieval. The resulting images may then be associated with corresponding transaction records stored in the application database 320 or retailer database 324, enabling users to visually verify return or refund progress directly through the single-view management application 110. In some embodiments, the screenshot service 326 may further incorporate OCR modules to extract text-based information (e.g., order numbers, dates, product names) from captured images, enhancing data completeness and searchability within the unified transaction management system.

The large language model 328 may implement advanced NLP and generative reasoning capabilities to facilitate context-aware interpretation and synthesis of user inputs and transaction data. For example, the LLM 328 may analyze text-based content from emails, chat messages, or screenshots to identify intent, classify transaction types, and extract key entities such as retailer names, purchase amounts, and return reasons. The LLM 328 may also generate coherent and contextually relevant responses or summaries, such as customer-facing updates, refund explanations, or retailer-specific return instructions, that can be displayed to the user via the web portal 304 or React Native® app 306.

In some embodiments, the LLM 328 may be fine-tuned or trained using domain-specific datasets comprising historical transaction records, retailer correspondence patterns, and user support interactions to improve accuracy in identifying return-related intents and contextual relationships. The outputs generated by the LLM 328 may be passed to downstream modules, such as the data summarization pipeline, rule-based reasoning engine, or notification service, for further validation, structuring, and action execution. Together, the screenshot service 326 and LLM 328 contribute to a more intelligent, transparent, and automated return/refund management experience, bridging visual and textual data sources within the single-view management application 110.

The pipeline 330 may refer to a dynamic data structure and orchestration mechanism that maintains and propagates input and output values throughout a sequence of interconnected flow services. It serves as a shared data bus that allows components within the unified transaction management framework to exchange intermediate and final processing results efficiently. The pipeline 330 may begin with the initial input received by a flow service, such as structured data extracted from user-submitted emails, screenshots, or messages, and may sequentially collect, transform, and pass along outputs from subsequent components, including the screenshot service 326, the LLM 328, and downstream services such as the parser 332 or Pub/Sub 318 service.

In some embodiments, the pipeline 330 may be implemented as an asynchronous event-driven architecture using message queues or stream processing frameworks (e.g., Apache® Kafka, Google® Dataflow, or Cloud Functions®) to ensure scalability and low-latency data transmission between services. Metadata such as timestamps, processing status, and source identifiers may be appended to each pipeline message to enable traceability and facilitate error handling or retry mechanisms. This structure ensures reliable and ordered delivery of data across the distributed components of the single-view management application 110.

The parser 332 may be a software component configured to process input data, such as unstructured or semi-structured text, and generate structured representations in the form of parse trees, abstract syntax trees (ASTs), or hierarchical data graphs. The parser 332 may utilize NLP techniques, regular expressions, or context-free grammars to identify key syntactic and semantic elements within the input, such as order identifiers, transaction amounts, timestamps, retailer names, and return reasons. In some embodiments, the parser 332 may also apply schema validation and data normalization rules to ensure consistency with predefined data models before passing the processed output to subsequent modules.

In some embodiments, the parsed data may be further consumed by the summarizer 334, which may act as a content-generation or abstraction module capable of synthesizing key order and refund details from the structured representation. The summarizer 334 may employ rule-based logic, template-driven generation, or AI-based summarization models (e.g., transformer architectures fine-tuned on transaction-related data) to create concise and human-readable summaries of return and refund activities. These summaries may include essential details such as order ID, merchant name, item category, refund amount, and current status.

In some embodiments, the summarized outputs generated by the summarizer 334 may be indexed and stored within the application DB 320 and/or the retailer DB 322. This allows for quick retrieval and visualization through the web portal 304 or the React Native® app 306. By linking the pipeline 330, parser 332, and summarizer 334 in a coordinated data flow, the system provides a robust and scalable mechanism for converting unstructured multi-source inputs into structured, actionable insights within the unified transaction management environment.

It should be noted, the components included in the backend 312 are merely for illustrative purposes, but not for limitations. In some embodiments, fewer or more components may be included in the backend server 312. For example, in some embodiments, the backend server 312 may further include an incentive generation unit 214 (not shown), the specific detail of which is further described in detail in FIG. 5.

FIG. 4 illustrates an example flow diagram 400 of an order collection process, according to some embodiments. As shown, the process may begin with the establishment of linked email credentials 402, which authorize the system to access a user's email account through secure authentication protocols (e.g., OAuth® 2.0, IMAP, or API-based access). This connection enables the email watcher 314 to monitor designated inboxes for order-related communications, such as purchase confirmations, shipping updates, or refund notifications. Upon detection, the collected email data may be transmitted via a webhook (e.g., Nylas® webhook 404), which serves as an event-driven HTTP endpoint configured to push structured message payloads to the backend system in real time.

The Nylas® webhook 404 may forward the collected data into a pipeline service 406, such as Google Cloud® Pub/Sub, AWS® simple notification service (SNS), or Apache® Kafka, which provides a scalable and asynchronous message queuing and routing mechanism. This pipeline service 406 ensures fault-tolerant delivery and allows concurrent downstream consumers to process messages independently. The email data within the pipeline may be enriched with metadata such as timestamps, message IDs, and user identifiers before reaching its target processing destination 408, where it undergoes various stages of automated analysis and transformation. These stages may include parsing, classification, and summarization by modules such as the parser 332 and the summarizer 334, which extract structured information (e.g., merchant, order ID, product description, and refund amount) from unstructured email content. The processed and summarized data may then be stored in the application database 320 and/or retailer database 324 for subsequent use in unified transaction management and user interface presentation.

As further illustrated in FIG. 4, in some embodiments, additional financial information associated with an order may also be retrieved and integrated into the unified order record. For example, linked Plaid® credentials 412 may be employed to securely access a user's financial account data through the Plaid® API, which provides a secure, tokenized connection between financial institutions and the disclosed system 100. This enables the system to retrieve payment transactions, refund confirmations, or billing details associated with specific orders related to return or refund. Similar to the email flow, the retrieved financial data may be transmitted via a Plaid® webhook 414, which publishes event notifications (e.g., completed transaction, pending refund) to the backend system. The Plaid® webhook 414 may interface with a same or different pipeline service 416 used in the email ingestion process to maintain consistent data flow and message handling architecture.

Upon receipt, the pipeline service 416 routes the financial data to a merging module 418, which correlates the incoming financial transactions with corresponding order records identified through shared attributes such as transaction IDs, merchant identifiers, or timestamps. The merged order thus contains both email-derived order details and finance-derived payment data, enabling a complete and unified view of the transaction. The finalized order data may be persisted via the order collection service 420, which stores and indexes the records for downstream processing, including refund verification, analytics, and reporting.

In some embodiments, the entire order collection process may be executed on the backend 312 in cooperation with the user application land 302. For example, the mobile app 424 (e.g., React Native® app) and the node API 422 on the user device may facilitate credential management, initiate data synchronization, and provide user-facing interfaces for linking accounts and viewing order status. The node API 422 may further handle encryption, token renewal, and communication between the mobile frontend and backend services, ensuring that sensitive data, such as email credentials and financial tokens, are securely transmitted and stored. Together, this architecture enables seamless, real-time aggregation of order and financial data into a single, coherent view for unified transaction management.

The above described various components and process flows are focused on the general return or refund request processing and monitoring. However, it is to be noted that the intelligent unified transaction system 100 disclosed herein is not limited to such functions. In some embodiments, the disclosed system may additionally generate an incentive offer to increase post-purchase engagement and customer retention.

Traditional loyalty systems often lack contextual awareness and timely engagement mechanisms, particularly in relation to financial events such as credits, returns, and refund transactions. These existing systems typically operate on static, post-purchase reward models that do not adapt to dynamic user behaviors or transactional states. As a result, these systems fail to engage customers during negative purchase experiences, such as refund or return events, when brand perception and customer retention are most at risk. Existing solutions merely provide generic offers or delayed incentives without leveraging transaction-level data to deliver meaningful re-engagement at critical moments.

Accordingly, there exists a need for a system and method capable of detecting and responding to refund events, analyzing associated transaction data to identify user intent, sentiment, and contextual opportunities for re-engagement in real time. Such a system may intelligently generate and deliver personalized, context-aware incentives, such as dynamic coupons, loyalty credits, or targeted product recommendations, designed to recapture lost revenue and enhance customer satisfaction following refund or return events. By integrating transaction analytics, behavioral modeling, and automated incentive delivery, the system may transform traditionally negative refund experiences into proactive engagement opportunities within a unified commerce and loyalty management framework.

FIG. 6 illustrates an example incentive generation unit 214 for generating and delivering personalized, context-aware incentives, according to some embodiments. As illustrated in the figure, the incentive generation unit 214 may include an event detection module 602, a behavior analysis engine 604, an offer generation engine 606, an offer selection pool 608, a delivery layer 610, and a feedback loop 612.

The event detection module 602 may be configured to continuously monitor and detect transaction-related activities indicative of refund events. These activities may include, but are not limited to, refund initiation events (e.g., when a customer submits a return request), return logistics events (e.g., when a shipment is scanned or received by a fulfillment center), and refund completion events (e.g., when funds are credited back to a user's financial account), as described earlier in FIGS. 1-4.

In some embodiments, the event detection module 602 may be integrated with various external systems such as retailer checkout and payment APIs, e-commerce platforms, customer relationship management (CRM) systems, logistics tracking platforms, or point-of-sale (POS) systems. Through such integrations, the module may access real-time transaction streams or event notifications via secure communication protocols, including RESTful APIs, webhooks, or message queues (e.g., GCP Pub/Sub or AWS® SNS), as described earlier.

Under certain scenarios where direct integrations with external systems are not available, the event detection module 602 may alternatively allow user-directed data integrations. For example, users may link their purchase histories, email receipts, or bank transaction data (e.g., through services such as Plaid) to the system. The module may then parse, normalize, and correlate this data to detect refund-related activity.

In some embodiments, the event detection module 602 may employ event-driven architectures and rule-based or AI-enhanced detection algorithms to identify refund events with high accuracy. Each detected event may be encapsulated with associated metadata, such as user ID, transaction ID, merchant identifier, refund amount, and event timestamp, and transmitted to downstream components for further processing. This enables real-time recognition of refund-related customer interactions, forming the foundation for personalized engagement and revenue recovery actions.

The behavior analysis engine 604 may be configured to evaluate customer behavior and compute a repurchase likelihood score that quantifies the probability of a user engaging in a future purchase following a refund or return event. In some embodiments, this engine may implement one or more AI or ML models trained on historical transaction and behavioral data. In some embodiments, the behavior analysis engine 604 may analyze various parameters, including but not limited to, historical order values, refund frequency, average time interval between purchases, product categories, engagement channel preferences, and sentiment indicators derived from customer communications or feedback. These inputs may be normalized and fed into predictive algorithms such as gradient boosting models, neural networks, or logistic regression classifiers to estimate a continuous or categorical likelihood score.

In some embodiments, the behavior analysis engine 604 may also perform behavioral segmentation, grouping customers into distinct clusters based on spending habits, responsiveness to incentives, and refund patterns. This segmentation may allow the system to tailor subsequent re-engagement strategies for each behavioral profile. The engine may dynamically adjust model weights or thresholds over time through reinforcement learning or continuous retraining mechanisms to improve prediction accuracy based on real-world outcomes (e.g., whether an incentive led to a successful repurchase).

In some embodiments, the resulting repurchase likelihood score and behavioral insights may be stored in association with the user's profile in the application database and transmitted to downstream components, such as the offer generation engine for use in generating personalized and context-aware re-engagement offers.

The offer generation engine 606 may be configured to dynamically generate and deliver optimized incentives based on the repurchase likelihood score and other behavioral or contextual factors. In some embodiments, the offer generation engine 606 may receive the computed repurchase likelihood score and corresponding behavioral segmentation data from the behavior analysis engine 604, along with real-time contextual inputs such as refund amount, product category, merchant type, and historical response to prior offers.

Using this data, offer generation engine 606 may determine the most effective incentive to maximize user engagement and recapture potential lost revenue. The generated incentive may include, but is not limited to, a digital coupon, discount code, store credit, loyalty point bonus, or free-shipping promotion. Each incentive may have associated parameters such as discount percentage, expiration period, applicable merchant category, and redemption conditions.

In some embodiments, the offer generation engine 606 may utilize a multi-objective optimization model that balances engagement probability, profitability, and user satisfaction. For example, the system may employ reinforcement learning, rule-based logic, or constrained optimization algorithms to match incentive types and values with corresponding user segments. Users with a higher repurchase likelihood score may receive more exclusive, time-sensitive, or high-value offers, while lower-score users may receive broader or exploratory offers designed to re-establish engagement.

In some embodiments, the offer generation engine 606 may further interface with external retailer APIs or coupon distribution systems to validate incentive availability and ensure compliance with partner-specific promotional rules. Once generated, the offer data may be formatted and transmitted to the downstream offer delivery layer 610 for presentation to the user via predefined communication channels (e.g., email, mobile app notification, or in-portal display). The system may log offer metadata, including timestamp, channel, and redemption tracking identifiers, to enable subsequent performance analysis and model refinement.

The offer selection pool 608 may serve as a centralized repository and decision layer that aggregates, classifies, and prioritizes available promotional incentives for use by the offer generation engine 606. In some embodiments, the offer selection pool 608 may contain structured records representing various offer types, including retailer-issued discounts, product-specific promotions, loyalty point rewards, free-shipping incentives, or third-party affiliate offers. Each record may include metadata such as retailer identification, product category, incentive value, expiration date, redemption conditions, historical success rate, and applicable user segments.

Offers within the pool may be organized or partitioned according to different logical dimensions, for example, by retailer, product category, projected incentive value, or conversion performance. The system may further maintain aggregated cross-retailer views to enable broader incentive optimization and substitution when a direct offer from the original retailer is unavailable or inapplicable. In such cases, the offer selection pool 608 may dynamically retrieve or integrate offers from affiliate marketing networks, advertising partners, or third-party loyalty providers through secured API interfaces.

In some embodiments, the offer selection pool 608 may incorporate ranking or scoring algorithms to determine offer suitability in real time. Factors influencing the ranking may include user behavioral profiles, repurchase likelihood, historical redemption rates, and contextual event data such as refund reason or transaction amount. The offer selection pool 608 may expose query endpoints to the offer generation engine 606, which may retrieve an optimized subset of offers matching specific criteria or probability thresholds.

Additionally, the offer selection pool 608 may employ machine learning models or heuristic rules to continuously refine offer prioritization based on engagement outcomes and redemption analytics. By maintaining a dynamic and adaptive repository of incentives, the offer selection pool 608 ensures that the system consistently selects and deploys the most relevant, personalized, and high-performing offers across retailers and customer segments, thereby maximizing re-engagement efficiency and revenue recovery potential.

The delivery layer 610 may be responsible for distributing and presenting the generated incentives to end users across multiple communication channels with minimal latency. In some embodiments, the delivery layer 610 may be integrated directly into retailer systems, a mobile application, and associated web portal interfaces as described earlier to ensure immediate and contextually relevant offer delivery. Incentives may be displayed or transmitted through various channels, including retailer return or refund confirmation pages, in-app notifications, web pop-ups, SMS messages, push notifications, and targeted email campaigns.

In some embodiments, to optimize engagement, the delivery layer 610 may prioritize real-time delivery, ensuring that incentives are communicated within seconds of a detected refund confirmation or related event. The layer may employ event-driven messaging frameworks and publish-subscribe systems (e.g., GCP Pub/Sub or AWS SNS) as described earlier, to trigger instantaneous message dissemination once the refund completion signal is received from the event detection module 602 or integrated retailer APIs.

In cases where a refund originates from a retailer or payment processor that is not directly integrated with the system, the delivery layer 610 may utilize alternate data sources to enable fallback delivery. These may include linked financial data streams (e.g., Plaid-based transaction monitoring), email parsing from confirmation messages, or third-party transaction aggregators. The delivery layer 610 may further coordinate with the offer generation engine 606 and offer selection pool 608 to verify incentive validity and adjust timing or channel preference based on the user's behavioral profile and prior responsiveness.

In some embodiments, delivery mechanisms may incorporate secure communication protocols (e.g., HTTPS, OAuth® 2.0, or tokenized message authentication) to safeguard user data and prevent unauthorized access. The delivery layer 610 may also maintain an event log of each transmission, tracking delivery success, view, click, and redemption events for use in downstream analytics, performance optimization, and feedback retraining of the behavior analysis engine 604. Through this architecture, the delivery layer 610 may enable seamless, secure, and contextually timed engagement that transforms refund moments into immediate opportunities for user reactivation and revenue recovery.

The feedback loop 612 may be configured to continuously monitor, collect, and analyze engagement metrics associated with incentive delivery and user interaction events. In some embodiments, the feedback loop 612 operates as a closed data pipeline connecting the delivery layer 610, offer generation engine 606, behavior analysis engine 604, and offer selection pool 608. It enables the system to dynamically refine incentive strategies and predictive models based on real-world user behavior and performance outcomes.

Tracked engagement metrics may include, but are not limited to, offer impressions, click-through rates, shares, in-app interactions, acceptance rates, redemption conversions, and expiration frequencies. These metrics may be captured through event logging frameworks embedded within the mobile app, web portal, or retailer integration endpoints. Data collection may occur in real time and be transmitted to backend analytics services through message queues or telemetry pipelines (e.g., Pub/Sub or Kafka) to ensure scalability and accuracy.

In some embodiments, the feedback loop 612 may employ machine learning-based analytics or statistical modeling techniques to evaluate campaign effectiveness and detect emerging behavioral patterns. For instance, the feedback loop 612 may analyze which combinations of offer types, values, and delivery timing yield the highest engagement for specific customer segments or refund contexts. The system may use this data to update parameters within the behavior analysis engine 604 (e.g., feature weighting for repurchase likelihood score computation) and to reprioritize incentives within the offer selection pool 608.

Additionally, the feedback loop 612 may incorporate reinforcement learning or adaptive optimization mechanisms that allow the system to autonomously improve over time. For example, if a specific coupon type consistently underperforms for a given refund category, its selection probability may be automatically reduced in future iterations. Conversely, highly effective incentives may be promoted within the offer hierarchy. Through this continuous evaluation and feedback process, the system ensures that future incentives are increasingly personalized, context-aware, and effective at driving post-refund engagement and revenue recovery.

In one exemplary implementation, when a refund transaction is completed and the refunded amount is credited back to a customer's payment method, the system automatically detects the event through its integrated data collection framework. This detection may occur via multiple input sources, including retailer APIs, financial account aggregators (e.g., Plaid), email ingestion services, and transactional data streams monitored by the event detection module 602. Upon confirmation of the refund event, the system timestamps and publishes the event as a moment (which is a time-sensitive engagement trigger) through the internal event bus or messaging service (e.g., GCP Pub/Sub). This publication initiates downstream workflows, including the execution of the behavior analysis engine 604, offer generation engine 606, and delivery layer 610, to generate and dispatch a personalized re-engagement offer in real time.

For instance, immediately following refund detection, the delivery layer 610 may send a push notification through the mobile application: “Your $72 refund has been processed and is back in your account. Here's 16% off your next order if you shop within the next 24 hours.” This notification represents a dynamically generated, context-aware incentive tailored to the user's refund history, behavioral profile, and repurchase likelihood. The offer is delivered within seconds (e.g., 1-2 seconds, 2-5 seconds, 5-10 seconds, 10-20 seconds, etc.) of the refund confirmation, transforming what is traditionally a neutral or negative transaction into an opportunity for positive re-engagement and revenue recovery. Subsequent user interactions with the offer, such as viewing, sharing, or redeeming it, are tracked by the feedback loop 612 to refine future incentive recommendations and improve the predictive accuracy of the system over time.

### Benefits and Advantages

The present intelligent transaction system overcomes the limitations of existing solutions by leveraging AI to receive and comprehend a variety of data sources with high accuracy. Unlike traditional systems that require extensive manual input to train multiple patterns and adapt to new patterns, the present system employs one or more AI models (e.g., LLMs) to synthesize information across a sequence of communications among different sources (e.g., retailer communications). The formats of source data are not restricted. For example, when an email including a refund order is received from a user, the present system may not only extract information from the email body but also dive into the attachment associated with the email. Additionally, if the source/input data includes other types of data (e.g., barcodes, images), the present system may perform OCR on the barcodes and decode information from the images. The present system may integrate data from various APIs. This cascading intelligence approach, where regex, ML, and multiple layers of LLMs work together, may allow for efficient and cost-effective data extraction and synthesis, providing a seamless experience for managing transactions (e.g., returns and refunds). As shown in FIGS. 1-4, to efficiently manage transactions from multiple sources or complex individual sources, the present system may perform operations such as data (e.g., email) ingestion and processing (e.g., by data collection unit 202), source (e.g., retailer) identification and status detection (e.g., by status detection unit 204), field extraction and post-processing (e.g., by field extraction unit 206), order matching and status updates (e.g., by status update unit 208), and intelligent template creation (e.g., by template creation unit 210). Various data (e.g., of various types, formats, sources, etc.) from users and output generated and presented to the users are communicated in the same portal (e.g., using a GUI module 212).

Among these operations, the present system is advantageous in various aspects. For example, in data (e.g., email) ingestion and synthesis, the present system is able to aggregate every related email, using information from the entire retailer communication sequence to build a complete return record. By using a cascading intelligence system, the present system may utilize regex, machine learning, and LLMs in a tiered approach to identify patterns, extract data, and train new extraction methods, offering a dynamic and adaptive solution. The present system may also apply deep data extraction. As discussed above, this goes beyond simple pattern matching by analyzing attachments, performing OCR on barcodes, and interfacing with external APIs to gather comprehensive information. For example, the AI-driven approach even includes purchase elements like letting people know when a return window is closing. Furthermore, regarding training and automation, the present system has the capacity to use LLMs to train regex and ML models, providing an automated way to generate new extraction templates and adapt to new retailer formats.

It is important to note that the present system accomplishes the functionalities (e.g., tracking orders, and processing returns) described herein in a unified view. The unified view can enhance efficiency by streamlining processes to reduce duplication of efforts and save time by integrating order management and return workflows. This also improves customer experience because customers can easily track their orders and returns in one place, leading to greater transparency and satisfaction. The unified implementation thus looks like a “skip the line” pass for returns and refunds, which no longer requires users to log into different accounts with retailers and financial organizations. In addition, the unified system may also allow for comprehensive data analysis and thus better data insights (e.g., helping trend identification in order fulfillment and return reasons). Errors are minimized and operational costs associated with handling returns and managing orders can be lowered when a unified view is used. This also allows consistent communication because customers receive consistent updates about their orders and returns, improving trust and reducing inquiries to customer service. The real-time tracking of returns helps transaction management. In addition, using a unified system, issues related to orders and returns may be addressed more quickly, enhancing overall operational agility. Overall, a unified system fosters a more cohesive and efficient approach to order management and returns.

Furthermore, by generating personalized offers immediately after a refund is completed, the system transforms a potentially negative user experience (return or refund) into a positive interaction. Instead of disengaging after a return, customers are re-engaged with timely, relevant incentives, increasing the likelihood of repeat purchases and brand loyalty. The process is fully automated, detecting refund events, generating offers, and delivering them via preferred channels (e.g., mobile app, SMS, email) without manual intervention. This ensures scalability across millions of transactions while maintaining personalization at the individual level.

System and/or Computer Embodiment

FIG. 7 depicts an example computing device 700 for implementing systems and methods described in reference to FIGS. 1-6. Examples of a computing device may include a personal computer, desktop computer laptop, server computer, a computing node within a cluster, message processors, hand-held devices, multi-processor systems, microprocessor-based or programmable consumer electronics, network PCs, minicomputers, mainframe computers, mobile telephones, PDAs, tablets, pagers, routers, switches, edge devices, IoT devices, and the like. In some embodiments, the computing device 700 may operate as an AI-powered unit. Thus, the computing device 700 may train and/or deploy machine learning models for monitoring the refund processes or other transactions.

In some embodiments, the computing device 700 includes at least one processor 702 coupled to a chipset 704. The chipset 704 includes a memory controller hub 720 and an input/output (I/O) controller hub 722. A memory 706 and a graphics adapter 712 are coupled to the memory controller hub 720, and a display 718 is coupled to the graphics adapter 712. A storage device 708, an input interface 714, and a network adapter 716 are coupled to the I/O controller hub 722. Other embodiments of the computing device 700 have different architectures.

The storage device 708 is a non-transitory computer-readable storage medium such as a hard drive, compact disk read-only memory (CD-ROM), DVD, or a solid-state memory device. The Memory 706 holds instructions and data used by the processor 702. The input interface 714 is a touch-screen interface, a mouse, a trackball, or other types of input interface, a keyboard, or some combination thereof, and is used to input data into the computing device 700. In some embodiments, the computing device 700 may be configured to receive input (e.g., commands) from the input interface 714 via gestures from the user. The graphics adapter 712 displays images and other information on the display 718. The network adapter 716 couples the computing device 700 to one or more computer networks.

The computing device 700 is adapted to execute computer program modules for providing the functionality described herein. As used herein, the term “module” refers to computer program logic used to provide the specified functionality. Thus, a module may be implemented in hardware, firmware, and/or software. In one embodiment, program modules are stored on the storage device 708, loaded into the memory 706, and executed by the processor 702.

The types of computing devices 700 may vary from the embodiments described herein. For example, the computing device 700 may lack some of the components described above, such as graphics adapters 712, input interface 714, and displays 718. In some embodiments, a computing device 700 may include a processor 702 for executing instructions stored in a memory 706.

The methods disclosed herein may be implemented in hardware or software, or a combination of both. In one embodiment, a non-transitory machine-readable storage medium, such as the one described above, is provided, the medium comprising a data storage material encoded with machine-readable data which, when using a machine programmed with instructions for using said data, is capable of displaying any of the datasets and execution and results of this disclosure. Such data may be used for a variety of purposes, such as patient monitoring, treatment considerations, and the like. Embodiments of the methods described above may be implemented in computer programs executing on programmable computers, comprising a processor, a data storage system (including volatile and non-volatile memory and/or storage elements), a graphics adapter, an input interface, a network adapter, at least one input device, and at least one output device. A display is coupled to the graphics adapter. Program code is applied to input data to perform the functions described above and generate output information. The output information is applied to one or more output devices in a known fashion. The computer may be, for example, a personal computer, microcomputer, or workstation of conventional design.

Each program may be implemented in a high-level procedural or object-oriented programming language to communicate with a computer system. However, the programs may be implemented in assembly or machine language, if desired. In any case, the language may be a compiled or interpreted language. Each such computer program is preferably stored on a storage medium or device (e.g., ROM or magnetic diskette) readable by a general or special-purpose programmable computer, for configuring and operating the computer when the storage medium or device is read by the computer to perform the procedures described herein. The system may also be considered to be implemented as a computer-readable storage medium, configured with a computer program, where the storage medium so configured causes a computer to operate in a specific and predefined manner to perform the functions described herein.

The signature patterns and databases thereof may be provided in a variety of media to facilitate their use. “Media” refers to a medium that contains the signature pattern information of the present disclosure. The databases of the present disclosure may be recorded on computer-readable media, e.g., any medium that may be read and accessed directly by a computer. Such media include, but are not limited to: magnetic storage media, such as floppy discs, hard disc storage media, and magnetic tape; optical storage media such as CD-ROM; electrical storage media such as RAM and ROM; and hybrids of these categories, such as magnetic/optical storage media. One skilled in the art may readily appreciate how any of the presently known computer-readable mediums may be used to create a manufacture comprising a recording of the present database information. “Recorded” refers to a process for storing information on a computer-readable medium, using any such methods as known in the art. Any convenient data storage structure may be chosen, based on the means used to access the stored information. A variety of data processor programs and formats may be used for storage, e.g., word processing text files, database format, etc.

What is claimed is:

1. A system for unified transaction management, comprising:
an email watcher configured to monitor a user's mailbox, detect new emails satisfying predefined conditions, and trigger a workflow for a new email satisfying the predefined conditions;
a Webhook configured to transmit structured or unstructured data from the email watcher to a messaging infrastructure;
a pipeline service configured to receive and distribute the structured or unstructured data as a message from the Webhook to downstream processing components;
a parser configured to convert unstructured data into structured data representations if data received from the pipeline service includes the unstructured data;
a summarizer configured to generate concise summaries of transaction information from the structured data or the structured data representations; and
a user application interface configured to present summarized transaction information in a unified, consistent user interface that consolidates transactions from multiple retailers into a single, cohesive dashboard.

2. The system of claim 1, wherein the pipeline service is a publish-subscribe messaging system configured to deliver messages to multiple subscribers including the parser and the summarizer.

3. The system of claim 1, wherein the summarizer operates on data drawn from multiple sources including email contents, metadata, screenshots, and attachments, to produce normalized transaction summaries.

4. The system of claim 1, wherein the user application interface includes a web portal providing modular content areas, wherein each of the modular content areas displays data from a particular source.

5. The system of claim 1, wherein the user application interface further includes a cross-platform mobile application to render adaptive layouts optimized for different devices.

6. The system of claim 1, wherein the user application interface further integrates with artificial intelligence (AI)-generated templates to enable adaptive rendering by dynamically reformatting visual elements or prompts based on a detected retailer, transaction type, or language pattern.

7. The system of claim 1, further comprising a WebSocket server configured to push real-time updates to the user application interface.

8. The system of claim 1, further comprising a screenshot service configured to capture visual representations of web pages related to a transaction, and extract textual data via optical character recognition.

9. The system of claim 1, further comprising a large language model (LLM) configured to extract intent, context, and key entities from the unstructured data.

10. The system of claim 9, wherein outputs from the LLM are provided to the parser for conversion into the structured data representations.

11. The system of claim 1, further comprising a template creation unit configured to automatically generate, adapt, or optimize one or more templates used by the system for data extraction, pattern recognition, and classification.

12. The system of claim 11, wherein the template creation unit utilizes a multi-layered artificial intelligence architecture that operates in a cascading manner.

13. The system of claim 12, wherein the multi-layered artificial intelligence architecture includes a first layer of pattern-recognition models for identifying basic syntactic structures, a second layer including statistical or machine learning-based models for clustering similar document types by layout, language, or content density, and a third layer, implemented through one or more large language models, for performing semantic interpretation and field association and mapping detected textual entities to conceptual categories associated with transactions.

14. The system of claim 1, further comprising an event detection module for detecting refund completion based on the parsed data or structured financial information.

15. The system of claim 14, further comprising an incentive generation module for generating an incentive upon a detection of the refund completion.

16. The system of claim 15, wherein the incentive is delivered within seconds of the refund completion.

17. A method for unified management of transaction data, comprising:
monitoring a user's mailbox to detect emails satisfying a specific type of transaction-related criteria;
forwarding structured or unstructured data derived from the detected emails via a Webhook to a pipeline service for distributing the structured or unstructured data as a message from the Webhook to downstream processing components;
parsing the unstructured data into structured data representations if data received from the pipeline service includes the unstructured data;
generating concise summaries of transaction information from the structured data or the structured data representation; and
presenting summarized transaction information in a unified, consistent user interface that consolidates transactions from multiple retailers into a single, cohesive dashboard.

18. The method of claim 17, further comprising capturing visual representations of web pages related to a transaction, and extracting textual data via optical character recognition.

19. The method of claim 17, further comprising detecting refund completion based on the parsed data or structured financial information.

20. The method of claim 19, further comprising generating an incentive upon a detection of the refund completion and delivering the incentive within seconds of the refund completion.
